(19) United States
(12) Patent Application Publication
(10) Pub. No.: US 2025/0219368 A1
(43) Pub. Date: Jul. 3, 2025

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yoshitaka YAMADA, Mie (JP); Koki SUMIDA, Mie (JP); Hayato OOI, Mie (JP); Toyoki FURUKAWA, Mie (JP)

(21) Appl. No.: 18/850,570

(22) PCT Filed: Mar. 27, 2023
(86) PCT No.: PCT/JP2023/012069

§ 371 Date: Sep. 25, 2024

(30) Foreign Application Priority Data
Mar. 31, 2022 (JP) 2022-058363

(51) Int. Cl. H02G 3/04; B60R 16/02

(52) U.S. Cl. CPC H02G 3/0456; B60R 16/0215

(57) ABSTRACT

A wire harness includes: a wire portion that includes an insulated wire and has a flat cross-sectional shape that is longer in a width direction than in a height direction; a pair of exterior members that are respectively in contact with two surfaces of the wire portion in the height direction; and a fixing member fixing the pair of exterior members to each other with the wire portion sandwiched between the exterior members, wherein the wire portion includes the insulated wire configured as a flat wire or a set of a plurality of the insulated wires, the exterior members are made of a material that has a higher tensile modulus than the insulating covering and have a higher bending flexibility than the wire portion in the height direction, and the fixing member fixes the pair of exterior members.

### DESCRIPTION

### Technical Field

The present disclosure relates to a wire harness.

### Background

Flat wires obtained using flat conductors are known. When a flat wire is used, it is possible to save a space occupied by the flat wire when the flat wire is routed, compared with a case where a generally used wire including a conductor that has a substantially circular cross section is used. For example, Patent Documents 1 and 2 filed by the applicants disclose, as flat wires that occupy a smaller space and have flexibility at the same time, insulated wires including wire conductors that are obtained by flattening twisted wires constituted by a plurality of strands twisted together.

Also, an exterior member has been commonly used to protect an insulated wire from contact or collision with external objects. A corrugated tube obtained by forming a resin material into a tubular shape that has a bellows structure is known as a type of such an exterior member. As shown in FIGS. 3A and 3B, a flat wire 2 may be inserted into a flat corrugated tube 8 to protect the wire 2. For example, Patent Document 3 discloses such a configuration in which a flat corrugated tube is used.

### PRIOR ART DOCUMENT

### Patent Document

Patent Document 1: WO 2019/093309

Patent Document 2: WO 2019/093310

Patent Document 3: JP 2012-249506 A

### SUMMARY OF INVENTION

### Technical Problem

As described above, it is possible to provide the flat wire 2 with a protective function by using the corrugated tube 8 having a flat shape like that shown in FIGS. 3A and 3B, but the flat corrugated tube 8 impairs bending flexibility of the flat wire 2. In particular, a large force is necessary to bend an assembly obtained by inserting the flat wire 2 into the flat corrugated tube 8 in a width direction (edge direction; x direction) of the flat wire. Accordingly, when a wire harness 9 obtained by inserting the flat wire 2 into the corrugated tube 8 is to be attached to a predetermined position inside an automobile, for example, it is not possible to easily perform work for bending the wire harness 9 at a position at which the wire harness 9 needs to be bent on its route. Even if the flat wire 2 is formed so as to have high flexibility as disclosed in Patent Documents 1 and 2, for example, the flexibility cannot be sufficiently utilized when the wire harness is routed.

Therefore, an object of the present disclosure is to provide a wire harness that can provide a protective function to a flat wire portion while securing high flexibility.

### Means to Solve the Problem

A wire harness according to the present disclosure includes: a wire portion that includes at least one insulated wire including a conductor and an insulating covering covering an outer circumferential surface of the conductor, a cross section perpendicular to an axial direction of the wire portion having a flat shape that is longer in a width direction than in a height direction; a pair of exterior members that are respectively in contact with two surfaces of the wire portion in the height direction; a fixing member fixing the pair of exterior members to each other with the wire portion sandwiched between the exterior members, wherein the wire portion includes one insulated flat wire or includes a set of a plurality of insulated wires, the exterior members are made of a material having a higher tensile modulus than the insulating covering and have a higher bending flexibility than the wire portion in the height direction, and the fixing member fixes the pair of exterior members to each other at a plurality of fixing positions spaced apart from each other in the axial direction of the wire portion.

### Effect of the Invention

A wire harness according to the present disclosure is a wire harness that can provide a protective function to a flat wire portion while securing high flexibility.

### BRIEF DESCRIPTION OF THE DRAWINGS

FIG. 1A is a perspective view of a wire harness according to an embodiment of the present disclosure, and FIG. 1B is a side view of the wire harness.

FIG. 2 is a cross-sectional view of the wire harness according to an embodiment of the present disclosure.

FIG. 3A is a perspective view of a conventional wire harness in which a flat corrugated tube is used, and FIG. 3B is a side view of the wire harness.

FIG. 4 is a cross-sectional view of the conventional wire harness in which a flat corrugated tube is used.

FIG. 5 is a perspective view of an integrated exterior member that constitutes a wire harness according to a variation.

FIG. 6 is a side view showing a method for evaluating a drooping amount of a wire.

FIG. 7 shows a photograph in which a drooping amount of a wire harness (H1) in which corrugated sheets were used and a drooping amount of a wire harness (H2) in which a corrugated tube was used are compared.

FIGS. 8A and 8B are graphs in which drooping amounts of samples are compared. FIG. 8A shows drooping amounts of the samples bent in a height direction, and FIG. 8B shows drooping amounts of the samples bent in a width direction.

### DETAILED DESCRIPTION TO EXECUTE THE INVENTION

### Description of Embodiments of the Present Disclosure

First, embodiments of the present disclosure will be listed and described.

A wire harness according to the present disclosure includes: a wire portion that includes at least one insulated wire including a conductor and an insulating covering covering an outer circumferential surface of the conductor, a cross section perpendicular to an axial direction of the wire portion having a flat shape that is longer in a width direction than in a height direction; a pair of exterior members that are respectively in contact with two surfaces of the wire portion in the height direction; and a fixing member fixing the pair of exterior members to each other with the wire portion sandwiched between the exterior members, wherein the wire portion includes one insulated flat wire or includes a set of a plurality of insulated wires, the exterior members are made of a material having a higher tensile modulus than the insulating covering and have a higher bending flexibility than the wire portion in the height direction, and the fixing member fixes the pair of exterior members to each other at a plurality of fixing positions spaced apart from each other in the axial direction of the wire portion.

The wire harness includes the exterior members that are in contact with the two surfaces of the flat wire portion in the height direction. The two surfaces in the height direction, which account for a large area in the flat wire portion, are covered by the exterior members made of a material having a higher tensile modulus than the insulating covering constituting the wire portion, and therefore, the wire portion is effectively protected from contact or collision with external objects. At the same time, the wire harness has high flexibility because the exterior members have a higher bending flexibility than the wire portion in a direction corresponding to the height direction of the wire portion. Furthermore, the fixing member fixing the pair of exterior members to each other is arranged at positions spaced apart from each other in the axial direction, and accordingly, the high flexibility of the exterior members is unlikely to be impaired even in the state where the exterior members are fixed by the fixing member. As a consequence of these, the wire harness as a whole has high flexibility while having high protective performance and can be easily bent at positions where the wire harness needs to be bent when routed in an automobile or the like, and high workability can be obtained when routing the wire harness.

Here, it is preferable that the exterior members have a higher bending flexibility than the wire portion in the width direction as well. This configuration is particularly advantageous in increasing the bending flexibility of the wire harness in the width direction.

It is preferable that the two exterior members are each configured as a sheet material that has a bellows structure including ridges and grooves arranged next to each other in the axial direction of the wire portion. If the exterior members have the bellows structure, the exterior members can have high bending flexibility even if the exterior members are made of a material that has a high tensile modulus and high protective performance. Consequently, the wire harness can have excellent bending flexibility.

It is preferable that, when the wire harness is supported so as to extend in a horizontal direction, the wire harness has, in both the width direction and the height direction, a drooping amount that is at least 70% of a drooping amount of the wire portion alone supported so as to extend in the horizontal direction. In this case, the bending flexibility of the wire portion is not significantly impaired by the exterior members provided on the wire portion, and the wire harness as a whole has excellent bending flexibility in both the width direction and the height direction.

It is preferable that the fixing member is constituted by a tape that has a higher flexibility than the exterior members. In this case, it is possible to effectively protect the wire portion by stably keeping the pair of exterior members in the state of sandwiching the wire portion, while maintaining the high bending flexibility of the wire harness as a whole.

In this case, it is preferable that the fixing member is spirally wound around an outer circumferential surface of an assembly constituted by the pair of exterior members and the wire portion with spaces left between turns of the fixing member in the axial direction of the wire portion. In this case, it is possible to easily fix the pair of exterior members to each other at the plurality of fixing positions spaced apart from each other.

It is preferable that the fixing member is not in contact with the wire portion except at end portions of the exterior members in the axial direction of the wire portion. In this case, the fixing member is unlikely to hinder flexible bending of the wire portion.

It is preferable that the pair of exterior members are each larger than the wire portion in the width direction. In this case, the exterior members can effectively protect the two surfaces of the wire portion in the height direction. At the same time, two surfaces of the wire portion in the width direction can be protected from contact with external objects to some extent. Moreover, it is possible to easily fix the exterior members to each other with the fixing portion by using portions of the exterior members protruding outward from the wire portion in the width direction.

It is preferable that the insulated wire is a flat wire that includes, as the conductor, a flat conductor obtained by flattening a twisted wire constituted by a plurality of strands that are twisted together. In this case, the wire harness has excellent flexibility because the conductor has high flexibility in the height direction and the width direction.

### Details of Embodiments of the Present Disclosure

The following describes an insulated wire and a wire harness according to an embodiment of the present disclosure in detail with reference to the drawings. In the present specification, concepts indicating the shape or arrangement of each member of the wire harness, such as “straight”, “parallel”, or “vertical” encompass geometric errors within a range that is allowable for this type of wire harness, for example, errors in a range of approximately ±15% in terms of length and errors in a range of approximately ±15° in terms of angle. In the present specification, cross sections of a wire harness, a wire, and an exterior member are cross sections that are perpendicular to an axial direction (longitudinal direction) unless otherwise stated. Also, various properties are evaluated at room temperature in the atmosphere.

### <Overview of Wire Harness>

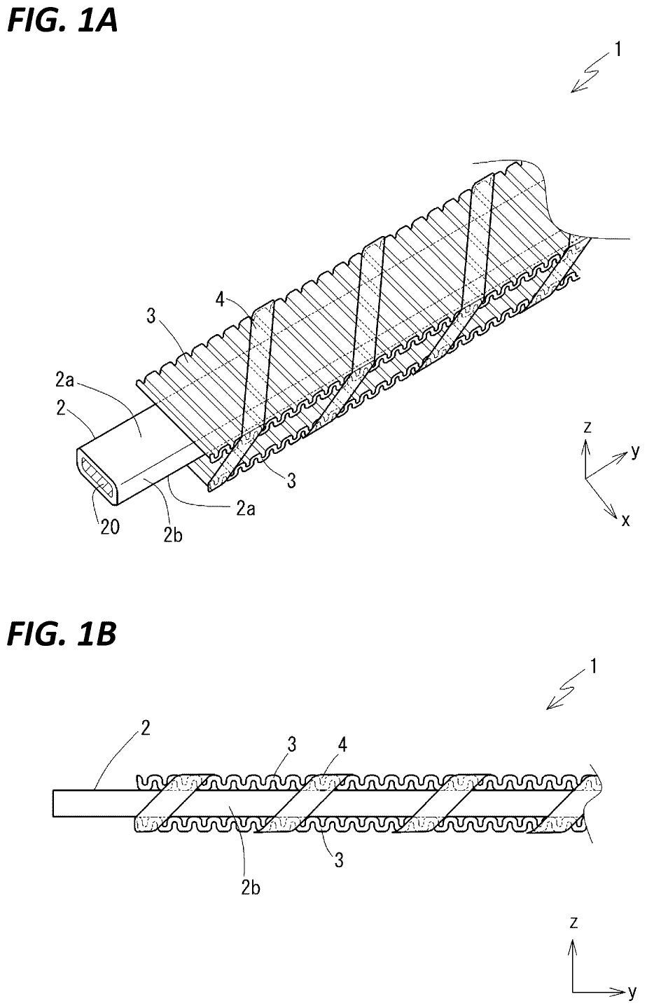

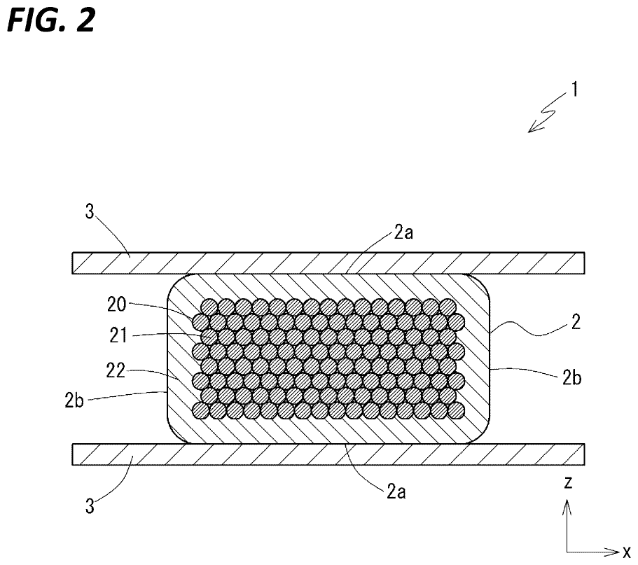

FIGS. 1A, 1B, and 2 show a structure of a wire harness 1 according to an embodiment of the present disclosure. FIG. 1A is a perspective view, FIG. 1B is a side view, and FIG. 2 is a cross-sectional view. The wire harness 1 according to the present embodiment includes a flat wire 2 as a wire portion, a pair of exterior members 3 and 3, and a tape 4 as a fixing member.

The wire portion included in the wire harness 1 includes at least one insulated wire including a conductor 20 and an insulating covering 22 covering an outer circumferential surface of the conductor 20, and the wire portion as a whole has a flat cross section that is orthogonal to the axial direction. In the present embodiment, the wire portion is constituted by a single insulated wire, and the insulated wire is configured as a flat wire 2 that has a flat cross section as a whole and in which the insulating covering 22 is formed on the outer circumferential surface of the conductor 20 that has a flat cross section. Here, “flat” means that the length of a cross section in a width direction is larger than the length of the cross section in a height direction perpendicular to the width direction. In the following description and the drawings, the width direction of a cross section of the flat wire 2 will be referred to as “x direction”, the height direction (up-down direction) will be referred to as “z direction”, and the axial direction (longitudinal direction) perpendicular to the x direction and the z direction will be referred to as “y direction”.

The pair of exterior members 3 and 3 are each configured as a sheet-shaped (including plate-shaped) member. The two exterior members 3 and 3 are respectively in contact with two surfaces (upper and lower surfaces 2a and 2a) of the flat wire 2 of the wire portion in the height direction. The exterior members 3 and 3 are in contact with the entire width of the upper and lower surfaces 2a and 2a of the wire portion. Preferably, the exterior members 3 and 3 are wider than the flat wire 2 of the wire portion as in the illustrated example, and the exterior members 3 and 3 protrude outward from the flat wire 2 in the width direction.

Although a material and a structure of the exterior members 3 and 3 will be described later in detail, the exterior members 3 and 3 are made of a material that has a higher tensile modulus than the insulating covering 22 constituting the flat wire 2 of the wire portion, and have a higher bending flexibility than the wire portion (here, the flat wire 2) in the height direction and preferably in the width direction as well. Although the material and the structure of the exterior members 3 and 3 are not specifically limited as long as these material characteristics are satisfied, in a preferred example, the exterior members 3 and 3 are constituted by corrugated sheets made of a resin material. The corrugated sheets are configured as sheet materials that have a bellows structure including ridges and grooves arranged next to each other in the axial direction of the wire.

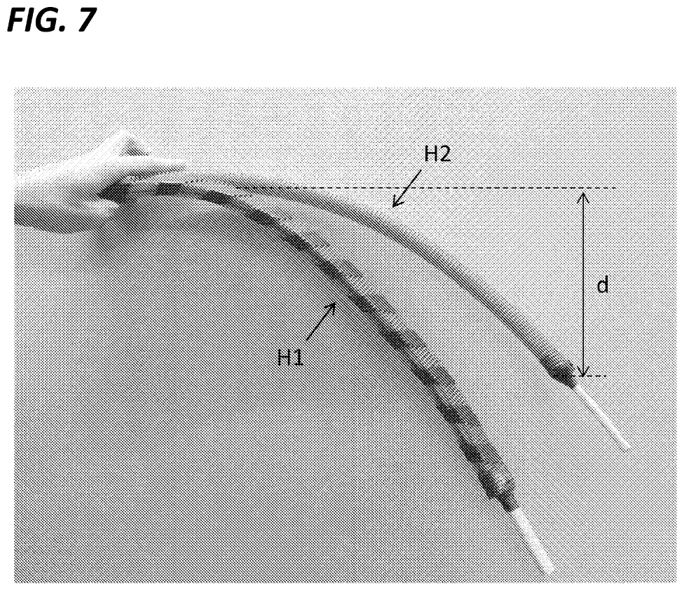

The fixing member constituted by the tape 4 fixes the pair of exterior members 3 and 3 to each other at a plurality of fixing positions spaced apart from each other in the axial direction of the flat wire 2. The tape 4 functions to stably maintain the state where the flat wire 2 is sandwiched by the exterior members 3 and 3 from above and below. In the illustrated configuration, an elongated continuous tape 4 is spirally wound around an outer circumferential surface of the assembly constituted by the pair of exterior members 3 and 3 and the flat wire 2 with spaces left between turns (pitch) of the tape 4. The position of each turn of the tape 4 is a fixing position. Since the tape 4 is wound in such a manner as to leave the spaces, side face portions 2b and 2b (surfaces on both sides in the width direction) of the flat wire 2 are not covered by the exterior members 3 and 3 and the tape 4 in regions where the tape 4 is not arranged, and the side face portions are directly exposed to the external environment in those regions. In the illustrated configuration, the width of the exterior members 3 and 3 is larger than the width of the flat wire 2, and the tape 4 is not in contact with the side face portions 2b and 2b of the flat wire 2. However, it is preferable to provide fixed portions (the fixed portions are omitted in FIGS. 1A and 1B; see FIG. 7) in which the exterior members 3 and 3 and the flat wire 2 are directly fixed with the tape 4 at end portions of the exterior members 3 and 3 in the longitudinal direction to prevent displacement of the flat wire 2 relative to the exterior members 3 and 3 in the axial direction, and the tape 4 may be directly in contact with the surface of the wire including the side face portions 2b and 2b in those fixed portions.

The following describes the constituent members of the wire harness 1 in detail.

### <Flat Wire>

The conductor 20 constituting the flat wire 2, which is the wire portion, may have a single wire structure constituted by a metal material that is a single continuous member as a whole, such as a metal foil or a metal plate, or may be constituted by a twisted wire obtained by twisting together a plurality of strands 21. From the standpoint of improving the flexibility of the flat wire 2 in both the height direction and the width direction, the conductor 20 is preferably configured as a twisted wire. Although the conductor 20 may have any cross-sectional shape as long as the cross-sectional shape is a flat shape, the conductor 20 in the present embodiment has a cross-sectional shape that is approximate to a rectangular shape. Examples of flat shapes other than a rectangular shape include an elliptical shape, an oval shape, a racetrack shape (shape including semicircles at two ends of a rectangle), a parallelogram shape, and a trapezoidal shape. In cases where the conductor 20 is configured as a twisted wire, the conductor 20 can be formed by rolling a raw material twisted wire obtained by twisting together the plurality of strands 21 and having a substantially circular cross-sectional shape. The flat wire 2 is obtained by forming the insulating covering 22 in such a manner as to cover the entire periphery of the conductor 20 having a flat cross-sectional shape.

The flat wire 2 includes the conductor 20 having a flat cross-sectional shape, and therefore, occupies a smaller space in the height direction than a conventionally-used common round wire that includes a conductor having the same cross-sectional area as the conductor 20 and a substantially circular cross-sectional shape, and this contributes to saving the space occupied by the flat wire 2. Moreover, the insulated wire 1 has high flexibility particularly in the height direction because the conductor 20 has a flat shape and a small length in the height direction.

There is no particular limitation on the material of the conductor 20, and various metal materials can be used. Representative examples of metal materials that can be used as the material of the conductor 20 include copper, copper alloys, aluminum, and aluminum alloys. In particular, aluminum and aluminum alloys have lower electrical conductivity than copper and copper alloys, and accordingly, when aluminum or an aluminum alloy is used, the cross-sectional area of the conductor tends to be large to secure the required electrical conductivity. Accordingly, the effect of flattening the conductor 20 to save the space occupied by the flat wire and increase the flexibility in the height direction is large. From this standpoint, the conductor 20 is preferably made of aluminum or an aluminum alloy. Also, from the same standpoint, the cross-sectional area of the conductor is preferably at least 10 mm², more preferably at least 50 mm², and further preferably at least 100 mm². Although an upper limit is not particularly set for the cross-sectional area of the conductor, the cross-sectional area is preferably not more than 200 mm² from the standpoint of securing the bending flexibility, for example.

Although there is no particular limitation on the material of the insulating covering 22 as long as the material is an insulating material, an organic polymer is preferably used as a base material of the insulating covering 22. In particular, polyvinyl chloride, polyolefin such as polyethylene, fluorocarbon resin, and silicone resin can be preferably used because of their high flexibility. When the cross-sectional area of the conductor is at least 10 mm², the insulating covering 22 made of these materials generally has a tensile modulus of not more than 200 MPa. The insulating covering 22 may contain various additives such as a flame retardant in addition to the organic polymer. Although there is no particular limitation on the thickness of the insulating covering 22, the thickness is at least 1 mm and 2 mm at most, for example.

### <Exterior Member>

As described above, the exterior members 3 and 3 are made of a material that has a higher tensile modulus than the insulating covering 22 constituting the flat wire 2 of the wire portion, and have a higher bending flexibility than the flat wire 2 (the wire portion as a whole) in the height direction. Furthermore, the exterior members 3 and 3 preferably have a higher flexibility than the flat wire 2 in the width direction as well.

Since the material of the exterior members 3 and 3 has a higher tensile modulus than the material of the insulating covering 22, the exterior members 3 and 3 sufficiently function as protective members that protect the flat wire 2 so that the flat wire 2 will not be significantly damaged due to external physical stimuli. That is to say, even if the wire harness 1 comes into contact with or collides with an external object, the exterior members 3 and 3 can protect the flat wire 2 from a large impact by absorbing the impact. Although the tensile modulus of the material of the exterior members 3 and 3 is not particularly specified, the tensile modulus is preferably at least 1000 MPa and 2000 MPa at most, for example. The tensile modulus is particularly preferably at least 1500 MPa. Note that the tensile modulus of a resin material can be evaluated by conducting a tensile test in accordance with JIS K7161.

From the standpoint of improving protective performance of the exterior members 3 and 3, the material of the exterior members 3 and 3 preferably has a higher hardness than the material of the insulating covering 2 in addition to having a higher tensile modulus than the material of the insulating covering 22. Note that, in the present specification, the tensile modulus and the hardness of a material are physical properties of the material itself and do not include effects of the shape of a member made of the material even if the member made of the material has a shape other than a simple planar shape, such as the bellows structure of the exterior members 3 and 3.

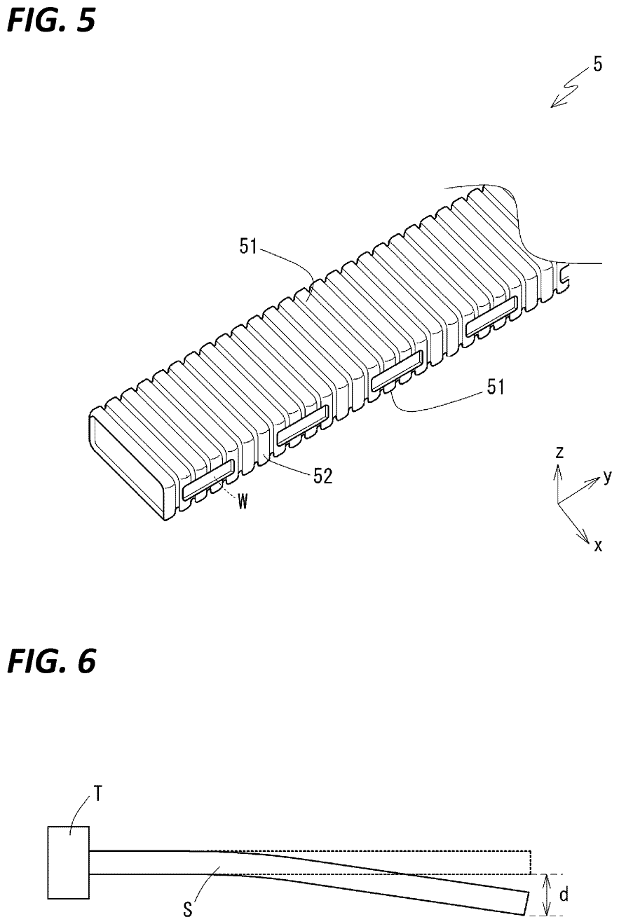

The protective performance is assured because the exterior members 3 and 3 have a high tensile modulus, and the wire harness 1 as a whole can have a high bending flexibility without the flexibility of the flat wire 2 being significantly impaired, because each exterior member 3 has a higher bending flexibility than the flat wire 2 at least in the height direction. In the present specification, the bending flexibility of a member is the flexibility of the member when the member is bent, and includes effects of the shape of the member such as the bellows structure of the exterior members 3 and 3. The exterior members 3 and 3 constituted by the corrugated sheets have a high flexibility in the width direction and the thickness direction (height direction). This is because the exterior members 3 and 3 are obtained by forming the material into the bellows structure that undulates in the up-down direction along the longitudinal direction, and the exterior members 3 and 3 can be stretched and compressed to some extent in the longitudinal direction, and therefore, when the exterior members 3 and 3 are bent in the width direction and when the exterior members 3 and 3 are bent in the thickness direction, the distance between adjacent ridges increases on the outer side of a curve and decreases on the inner side of the curve, and thus the exterior members 3 and 3 can flexibly conform to the curve. The bending flexibility of the exterior members 3 and the bending flexibility of the flat wire 2 can be compared by conducting a three-point bending test, for example, but it is also possible to compare the bending flexibilities simply by comparing drooping amounts of the exterior member 3 and the flat wire 2 that are held so as to extend horizontally (see FIG. 6). In a comparison between an exterior member 3 and the single flat wire 2 that are cut to the same length, the drooping amount of the exterior member 3 is preferably larger than the drooping amount of the flat wire 2 at least when the exterior member 3 and the flat wire 2 are positioned such that height directions thereof extend in the gravity direction. Also, it is preferable that, when the exterior member 3 and the flat wire 2 are positioned such that width directions thereof extend in the gravity direction, the drooping amount of the flat wire 2 is equivalent to (approximately at least 90%) of the drooping amount of the exterior member 3.

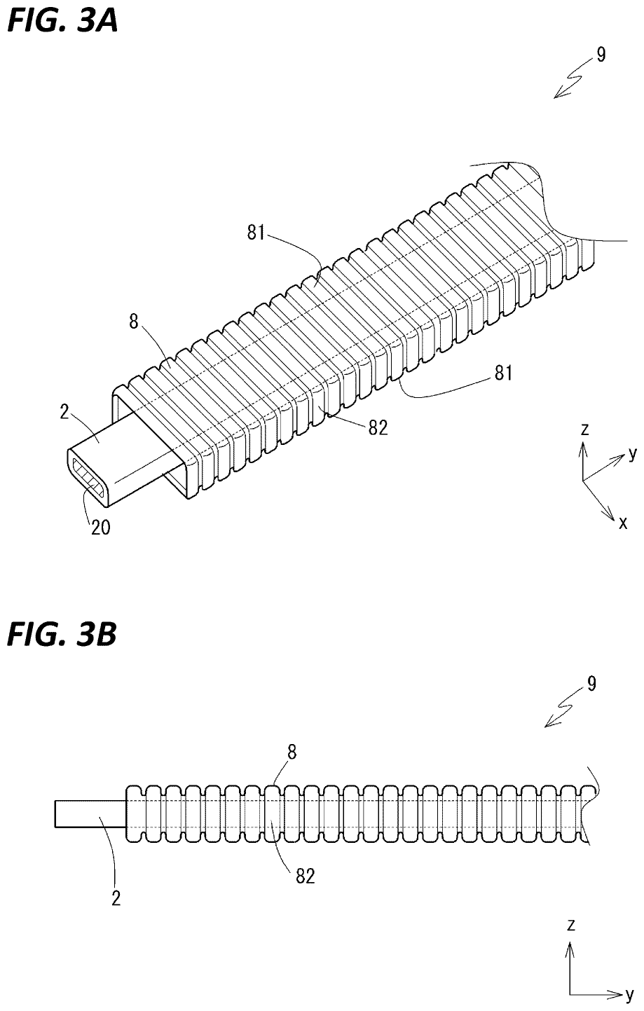

Although there is no particular limitation on the material of the exterior members 3 and 3, it is possible to preferably use a resin material such as polypropylene, polyamide, or polyester because these resin materials have a high tensile modulus and exhibit high protective performance. When the exterior members 3 and 3 are made of these materials, the tensile modulus of the exterior members 3 and 3 tends to fall within the above-described range of at least 1000 MPa and 2000 MPa at most. The exterior members 3 and 3 may contain various additives such as a flame retardant in addition to an organic polymer. Although there is no particular limitation on the thickness of the sheet materials constituting the exterior members 3 and 3, the thickness is at least 0.2 mm and 1 mm at most, for example. The bellows structure has a height (a height between a groove and a ridge in the height direction z) of at least 1 mm and 3 mm at most and a pitch (a distance between adjacent ridges in the longitudinal direction y) of at least 2 mm and 5 mm at most, for example. As the exterior members 3 and 3 of the present embodiment, it is possible to preferably use members obtained by forming a material similar to a wall portion of a conventionally-used common corrugated tube like that shown in FIGS. 3A and 3B into sheets including ridges and grooves arranged next to each other in the longitudinal direction.

### <Tape>

The type of the tape 4 used as the fixing member is not particularly limited as long as the tape 4 is constituted by an elongated sheet material. However, from the standpoint of stably maintaining the structure in which the exterior members 3 and 3 are fixed, it is preferable to use a tape 4 that includes an adhesive layer (including a pressure-sensitive adhesive layer) on a surface thereof that comes into contact with the exterior members 3 and 3.

The tape 4 preferably has a higher flexibility than the exterior members 3 and 3 in each direction so as not to impair the flexibility of the exterior members 3 and 3. Furthermore, it is preferable that the tensile modulus of the material of the tape 4 is lower than the tensile modulus of the material of the exterior members 3 and 3 and also lower than the tensile modulus of the material of the insulating covering 22. Preferred examples of the material of the tape 4 include a material that includes an adhesive layer provided on a surface of a substrate made of polyvinyl chloride or the like. A commercially-available tape formed from these materials generally has a tensile modulus of not more than 50 MPa.

### <Protective Performance and Flexibility of Wire Harness>

In the wire harness 1 according to the present embodiment, the exterior members 3 and 3 are provided on both surfaces 2a and 2a of the flat wire 2 in the height direction. Therefore, the flat wire 2 is protected by the exterior members 3 and 3 and unlikely to be affected by physical stimuli such as contact or collision with external objects. High protective performance can be obtained because the exterior members 3 and 3 have a higher tensile modulus than the insulating covering 22 of the flat wire 2.

The upper and lower surfaces 2a and 2a in the height direction of surfaces of the flat wire 2 constituting the wire harness 1 have large areas. A high effect of protecting the flat wire 2 can be obtained by providing the exterior members 3 and 3 to cover these surfaces 2a and 2a. The effect of protecting the flat wire 2 is particularly high if the exterior members 3 and 3 are wider than the flat wire 2 and cover the entire width of the upper and lower surfaces 2a and 2a in the height direction of the flat wire 2. The side face portions 2b and 2b (surfaces on both sides in the width direction) of the flat wire 2 are not covered by the exterior members, but the flat wire 2 has a flat shape and accordingly, the side face portions 2b and 2b have small areas and a reduction in the performance of protecting the flat wire 2 as a whole due to the side face portions 2b and 2b not being covered by the exterior members is limited. Also, if the exterior members 3 and 3 are wider than the flat wire 2 and protrude outward from the flat wire 2 in the width direction, the side face portions 2b and 2b of the flat wire 2 are also protected from contact with external objects to some extent by protruding portions of the exterior members 3 and 3.

In the wire harness 1 according to the present embodiment, high protective performance can be obtained due to the exterior members 3 and 3, and the wire harness 1 as a whole has high flexibility because the exterior members 3 and 3 are provided only on the upper and lower surfaces of the flat wire 2 in the height direction and are not provided on both sides in the width direction. As described above, the pair of exterior members 3 and 3 each have a higher flexibility than the flat wire 2 at least in the height direction, and the exterior members 3 and 3 are disposed so as to sandwich the flat wire 2 from above and below in the height direction, and accordingly, the wire harness 1 as a whole can exhibit high flexibility when it is bent in the height direction (flat direction) as well as when it is bent in the width direction (edge direction).

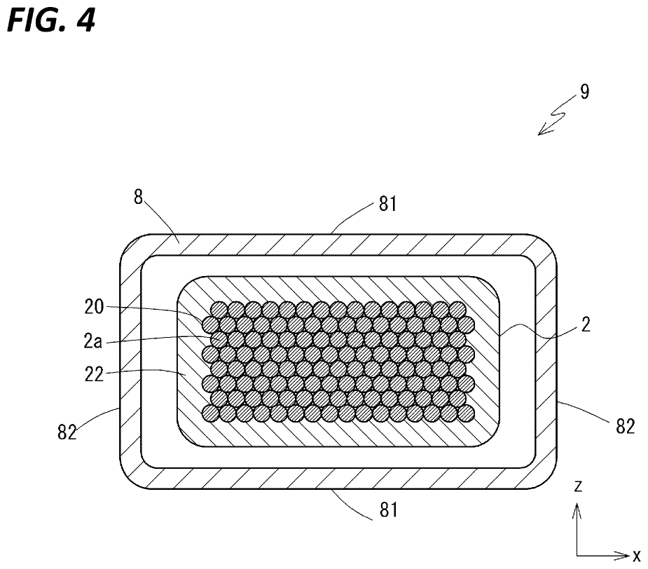

Here, in the case of a wire harness 9 obtained by inserting the flat wire 2 into a flat corrugated tube 8 as shown in the perspective view of FIG. 3A, the side view of FIG. 3B, and the cross-sectional view of FIG. 4, the material of the corrugated tube 8 surrounds the entire circumference of the flat wire 2, and therefore, the wire harness 9 cannot exhibit high flexibility when it is bent in the width direction (x direction) and the height direction (z direction). This is because upper and lower surfaces 81 and 81 of the corrugated tube 8 are coupled into a single piece by side wall surfaces 82 and 82 extending in the up-down direction, and the corrugated tube 8 has a large moment of inertia of area. Particularly when the wire harness 9 is bent in the width direction, the side wall surfaces 82 and 82 of the corrugated tube 8 need to be deformed in their planes in such a manner as to be compressed on the inner side of a curve and stretched on the outer side of the curve, and therefore, a large force is required even though the corrugated tube 8 has a bellows structure.

On the other hand, in the wire harness 1 according to the embodiment of the present disclosure, the pair of upper and lower exterior members 3 and 3 are not coupled into a single piece but are configured as separate members and sandwich the flat wire 2, and accordingly, a total moment of inertia of area of the two exterior members 3 and 3 is smaller than the moment of inertia of area of the corrugated tube 8 described above. Therefore, the wire harness 1 has high flexibility in both the width direction and the height direction.

In the wire harness 1 according to the present embodiment, the tape 4 serving as the fixing member fixes the upper and lower exterior members 3 and 3 to each other and functions to stably maintain the state where the flat wire 2 is sandwiched between the exterior members 3 and 3, and the arrangement of the tape 4 also contributes to increasing the flexibility of the wire harness 1. If the tape 4 is wound around the flat wire 2 with no spaces left between turns of the tape 4 along the axial direction, the flat wire 2 is held more stably, but the flexibility of the wire harness as a whole decreases, and the flexibilities of the flat wire 2 and the exterior members 3 and 3 are unlikely to be exhibited as the flexibility of the wire harness as a whole. On the other hand, if the tape 4 is wound with spaces left between turns of the tape 4 and the upper and lower exterior members 3 and 3 are fixed only at the fixing positions spaced apart from each other in the axial direction of the flat wire 2, the wire harness 1 as a whole maintains high flexibility.

It is possible to control the flexibility of the wire harness 1 to some extent by adjusting the arrangement of the tape 4. If the tape 4 is wound at a small pitch by reducing the size of spaces between turns of the tape 4, and if the tape 4 is wound tightly to strongly press and fix the upper and lower exterior members 3 and 3 against the flat wire 2, the state where the flat wire 2 is sandwiched between the pair of exterior members 3 and 3 is maintained more stably and the flat wire 2 is protected more reliably, but the flexibility of the wire harness 1 decreases. On the other hand, if the tape 4 is wound at a large pitch by leaving large spaces between turns of the tape 4, and if the tape 4 is wound loosely to keep the upper and lower exterior members 3 and 3 from being strongly pressed against the flat wire 2, the protective performance of the exterior members 3 and 3 may deteriorate, but the wire harness 1 as a whole can have high flexibility. This is because relative movement of the flat wire 2 is allowed to some extent in the space between the pair of exterior members 3 and 3, and therefore, the flat wire 2 can bend flexibly.

When the tape 4 is wound, the size of spaces between turns of the tape 4 and the degree of tightness of the tape 4 can be selected in view of protective performance and flexibility required for the wire harness 1. In a preferred configuration with which sufficient protective performance and sufficient flexibility can be achieved at the same time, the size of spaces between turns of the tape 4 is set such that a ratio (b/a) of an area (b) of regions covered by the tape 4 to an entire area (a) of the outer circumferential surface of the wire harness 1 is at least 5% and 95% at most, for example. Also, the tightness of the tape 4 is set such that the exterior members 3 and 3 elastically deform in the thickness direction by being pressed by the tape 4 that is in contact with the exterior members 3 and 3 (i.e., portions of the exterior members 3 and 3 on which the tape 4 is wound are compressed), but the insulating covering 22 does not deform, for example.

The flexibility of the wire harness 1 as a whole can be evaluated simply based on an amount by which the wire harness 1 droops under its own weight. As shown in FIG. 6, an end of a test piece S (wire harness) is held so as to extend in the horizontal direction with use of a jig T or the like, and a distance d by which another end of the test piece droops from the horizontal position under its own weight is taken to be a drooping amount. The flexibility of the flat wire 2 in the width direction can be evaluated based on a drooping amount of the flat wire 2 positioned in such a manner that the width direction of the flat wire 2 extends in the gravity direction, and the flexibility of the flat wire 2 in the height direction can be evaluated based on a drooping amount of the flat wire 2 positioned in such a manner that the height direction of the flat wire 2 extends in the gravity direction. It can be concluded that the larger the drooping amount is, the higher the flexibility is.

The flexibility of the wire harness 1 can be evaluated by comparing a drooping amount of the wire harness 1 with a drooping amount of the flat wire 2 alone, which is cut to the same length as the wire harness 1 and of which the drooping amount is evaluated in the same manner as that described above. It is preferable that the drooping amount of the wire harness 1 is at least 60% of the drooping amount of the flat wire 2 alone in both the width direction and the height direction, for example. It is more preferable that the drooping amount of the wire harness 1 is at least 70% of the drooping amount of the flat wire 2 alone. In this case, it can be said that the wire harness 1 as a whole has sufficiently high flexibility. The arrangement of the tape 4 can be set to realize a drooping amount of the wire harness 1 of this level.

On the other hand, it is also possible to obtain an effect of keeping the wire harness 1 in a predetermined bent shape by reducing the size of spaces between turns of the tape 4 to some extent and tightly winding the tape 4. For example, if the tape 4 is wound around an outer circumferential surface of an assembly constituted by the flat wire 2 and the exterior members 3 and 3 in a state where the flat wire 2 and the exterior members 3 and 3 are bent into a predetermined bent shape required due to a wiring route or the like, it is possible to maintain the bent shape. If the wire harness 1 is routed in a predetermined place such as the inside of an automobile with the bent shape maintained as described above, the wire harness 1 need not be bent significantly when it is routed, and workability improves. In this case as well, the upper and lower exterior members 3 and 3 are configured as separate members and fixed to each other by the tape 4, and accordingly, the wire harness 1 has a higher flexibility when compared with the case where the corrugated tube 8 is used.

The tape 4 may be in contact with the surface of the flat wire 2 in the side face portions 2b and 2b of the flat wire 2. However, from the standpoint of assuring the freedom of relative movement of the flat wire 2 in the space between the pair of exterior members 3 and 3 and increasing the flexibility of the wire harness 1, it is preferable that the tape 4 is not in contact with the flat wire 2 except in the end portions of the exterior members 3 and 3 in the longitudinal direction. In the case where the exterior members 3 and 3 are wider than the flat wire 2, the tape 4 wound on the outer circumferential surfaces of the exterior members 3 and 3 is unlikely to come into contact with the flat wire 2.

### Other Embodiments

In the above embodiment, the wire portion is constituted by the single flat wire 2, the exterior members 3 and 3 are constituted by the pair of corrugated sheets, and the fixing member is constituted by the tape 4, but members of the wire harness according to the present disclosure are not limited to these. The following simply describes major variations.

The wire portion may include only one insulated wire that is configured as the flat wire 2 as described above or a set of insulated wires as long as the wire portion as a whole has a flat cross-sectional shape. In the case where the wire portion includes a plurality of insulated wires, those insulated wires may be flat wires or conventionally-used common round wires that have a substantially circular cross-sectional shape. In any case, it is sufficient that the plurality of insulated wires are arranged next to each other in the width direction, and the set of insulated wires as a whole has a flat cross-sectional shape that is long in the width direction. As long as the set of insulated wires has a flat cross-sectional shape that is long in the width direction, the plurality of insulated wires may also be arranged in a plurality of rows in the height direction as well as in the width direction.

It is advantageous to use the tape 4 as the fixing member as described above from the standpoint of the high flexibility of the tape 4, for example. However, the fixing member is not limited to the tape as long as the fixing member can fix the pair of exterior members 3 and 3 to each other at a plurality of fixing positions spaced apart from each other in the axial direction of the wire portion. For example, the upper and lower exterior members 3 and 3 may also be fixed to each other by being bonded with an adhesive agent or being fused at the fixing positions spaced apart from each other. Alternatively, it is also possible to fix the upper and lower exterior members 3 and 3 to each other by disposing pin-shaped fixing members so as to be spaced apart from each other, for example.

In another embodiment, the fixing member may also be formed from the same material as the exterior members. In this case, the upper and lower exterior members and the fixing member may also be formed into a single piece. FIG. 5 shows an integrated exterior member 5 as an example of such an embodiment in which the fixing member and the exterior members are formed into a single piece. The integrated exterior member 5 includes a pair of upper and lower exterior members 51 and 51 and a fixing member 52 coupling the exterior members 51 and 51 together. The fixing member 52 is constituted by a sheet material having a bellows structure similarly to the upper and lower exterior members 51 and 51, and ridges and grooves of the bellows structure are arranged next to each other in the longitudinal direction (y direction) in the fixing member 52 as in the exterior members 51 and 51. The integrated exterior member 5 obtained by forming the exterior members 51 and 51 and the fixing member 52 as a single piece as described above can be easily formed with use of a flat corrugated tube 8 like that used in the wire harness 9 shown in FIGS. 3A and 3B. That is to say, a plurality of cutout portions W can be formed as through holes like windows in side wall surfaces 82 and 82 of the corrugated tube 8. Upper and lower surfaces 81 and 81 of the corrugated tube 8 function as the exterior members 51 and 51, and the side wall surfaces 82 and 82 other than the cutout portions W function as the fixing member 52.

### EXAMPLES

The following describes examples. Note that the present invention is not limited by these examples. Here, a case where corrugated sheets are used as the exterior members and a case where a corrugated tube is used were compared in terms of flexibility in the height direction and the width direction.

### (Production of Samples)

A flat wire was prepared as a wire portion. A round wire constituted by a twisted wire made of an aluminum alloy was rolled into a flat shape with use of a roller to obtain a flat conductor, and an insulating covering was formed on an outer circumferential surface of the conductor through extrusion molding. Strands that were used had an outer diameter of 0.3 mm, and the conductor had a cross-sectional area of 50 mm². The insulating covering was made of polyvinyl chloride and had a thickness of 1 mm. The material of the insulating covering had a tensile modulus of 20 MPa. After the insulating covering was formed, the flat wire had a width of 19 mm and a height of 8 mm.

Corrugated sheets and a corrugated tube were prepared as two types of exterior members. Each type of the exterior members was formed from a polyamide material having a thickness of 1 mm and ridges and grooves arranged next to each other in the longitudinal direction. The height (height between a groove and a ridge in the height direction) of the corrugated structure (bellows structure) was 3 mm, and the width (distance between adjacent ridges in the longitudinal direction) of the corrugated structure was 4 mm. The material of the exterior members had a tensile modulus of 1×10³ MPa. The corrugated sheets were formed as elongated sheets having a width of 30 mm. The corrugated tube was formed as a tube having a flat cross-sectional shape and an external shape with a width of 40 mm and a height of 18 mm.

Harnesses 1 and 2 were produced as wire harnesses with use of the flat wire and the exterior members. The corrugated sheets were used as the exterior members of the harness 1. The exterior members were respectively brought into contact with two surfaces of the single flat wire in the height direction, and a tape was wound around an outer circumferential surface of the thus obtained assembly to fix the exterior members to each other, and thus a wire harness having the structure shown in FIGS. 1A, 1B, and 2 was produced. The tape used included an adhesive layer provided on a surface of a polyvinyl chloride sheet and was wound such that turns of the tape were spaced apart from each other by 30 mm (a distance in the axial direction of the flat wire).

On the other hand, a wire harness having the structure shown in FIGS. 3A, 3B, and 4 was produced as the harness 2 by inserting the flat wire into the corrugated tube. In both of the harnesses 1 and 2, the flat wire had a length of 600 mm and the exterior members had a length of 500 mm in the axial direction, and the flat wire protruded by 50 mm from each end portion of the exterior members in the axial direction. Also, the exterior members were fixed to the flat wire with use of a tape at both end portions of the exterior members. In the harness 1, the tape was kept from coming into contact with the flat wire except in the end portions at which the tape was fixed to the flat wire.

### (Test Method)

The harnesses 1 and 2 described above, and the flat wire, the corrugated sheets, and the corrugated tube constituting the wire harnesses were each evaluated in terms of a drooping amount when they drooped under their own weights. In the evaluation, an end of each test piece S was held so as to extend in the horizontal direction, and a distance d by which another end of the test piece drooped from the horizontal position under its own weight was measured as a drooping amount as shown in FIG. 6, and drooping amounts of samples were compared. The test was conducted in two ways, i.e., by positioning each sample such that the height direction (thickness direction; flat direction) of the sample extended in the gravity direction and by positioning each sample such that the width direction (edge direction) of the sample extended in the gravity direction. The harnesses 1 and 2 having the dimensions described above regarding the production of the samples were used as they were, and the corrugated sheets and the corrugated tube were each cut to 500 mm and used alone in the test. The flat wire was cut to 500 mm for comparison with the corrugated sheet and the corrugated tube, and was cut to 600 mm for comparison with the harnesses 1 and 2. As for the harnesses 1 and 2, the drooping amount was measured in a region where the corrugated sheets were provided as shown for the harness 2 (H2) in FIG. 7.

### (Test Results)

FIG. 7 shows a photograph showing the state where the test was conducted to measure the drooping amount by comparing the harnesses 1 and 2. Here, the harnesses were positioned such that the height direction of the flat wire extended in the gravity direction to compare flexibilities of the harnesses in the height direction. As shown in the photograph, the drooping amount of the harness 1 (H1) obtained by using the corrugated sheets was significantly larger than the drooping amount of the harness 2 (H2) obtained by using the corrugated tube. That is to say, it can be found that the flexibility of the harness 1 is noticeably higher than the flexibility of the harness 2.

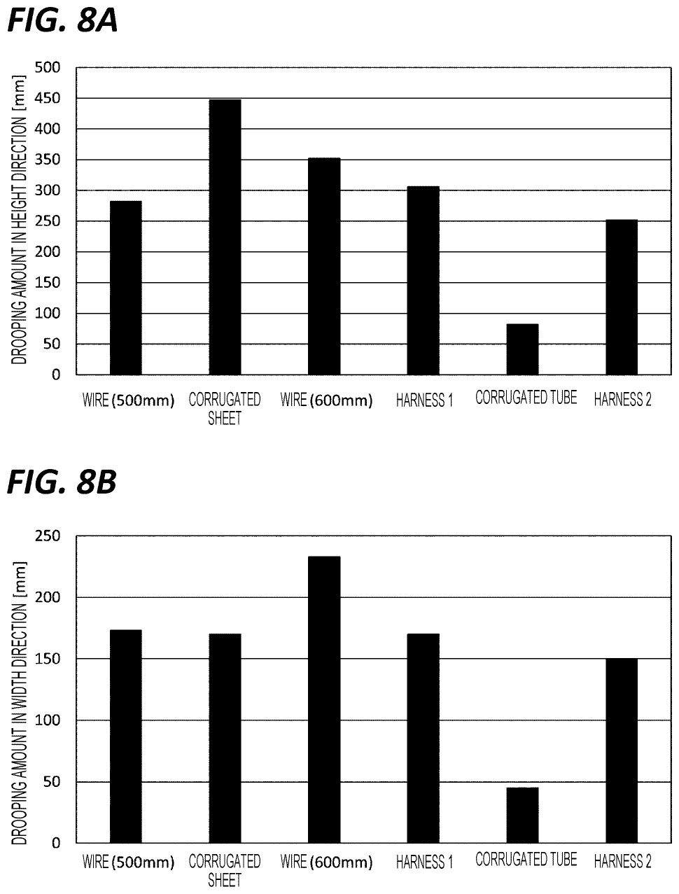

Also, FIGS. 8A and 8B show results of the evaluation of drooping amounts of the harnesses 1 and 2, test pieces obtained by cutting the flat wire (abbreviated as “wire” in the diagrams) to the two lengths, and the two types of exterior members. FIG. 8A shows drooping amounts in the height direction, and FIG. 8B shows drooping amounts in the width direction.

When the drooping amount of the flat wire with a length of 500 mm and the drooping amount of the corrugated sheet are compared in each of FIGS. 8A and 8B, the corrugated sheet had a larger drooping amount than the flat wire in the height direction. The drooping amount of the flat wire and the drooping amount of the corrugated sheet were equivalent in the width direction. That is to say, it was confirmed that the corrugated sheet apparently had a higher bending flexibility than the flat wire at least in the height direction. In view of the fact that the flat wire had a larger mass than the corrugated sheet, it can be said that a difference between bending flexibilities of the corrugated sheet and the flat wire when the influence of their weights is excluded is larger than a difference between the drooping amounts of the corrugated sheet and the flat wire. There was only a slight difference between the drooping amounts of the corrugated sheet and the flat wire in the width direction, and in view of the fact that the flat wire had a larger mass than the corrugated sheet, it can be said that the corrugated sheet had a higher flexibility than the flat wire in the width direction as well.

Next, when the drooping amount of the harness 1 obtained by using the corrugated sheets and the drooping amount of the harness 2 obtained by using the corrugated tube are compared in each of FIGS. 8A and 8B, the harness 1 had a larger drooping amount than the harness 2 in both the height direction and the width direction. That is to say, the harness 1 had a higher bending flexibility than the harness 2 in both the height direction and the width direction. The harness 1 had a mass of 160 g, and the harness 2 had a mass of 175 g, which is larger than the mass of the harness 1. That is to say, it can be said that the harness 1 had a higher bending flexibility than the harness 2 in both the height direction and the width direction even when the influence of their weights is excluded.

When the drooping amount of the harness 1, which is a wire harness obtained by using the corrugated sheets, and the drooping amount of the flat wire alone are compared, the drooping amount of the harness 1 was about 90% of the drooping amount of the flat wire (600 mm) in the height direction and was about 70% of the drooping amount of the flat wire in the width direction. The harness 1 had a larger mass than the flat wire due to including the corrugated sheets and the tape, and it is not possible to simply determine which of the harness 1 and the flat wire had a higher bending flexibility, based on their drooping amounts. However, generally, it can be said that if the drooping amount of the wire harness is at least 70% of the drooping amount of the flat wire, the bending flexibility of the flat wire is maintained at a sufficiently high level even in the state where the flat wire is included in the wire harness obtained by using the corrugated sheets and the tape.

From the test results described above, it was confirmed that, when a wire harness is obtained by using corrugated sheets having a higher bending flexibility than a flat wire as exterior members, sandwiching upper and lower surfaces of the flat wire in the height direction between the exterior members, and fixing the exterior members with a tape, the wire harness can have higher flexibility when it is bent in the height direction and the width direction, compared with a case where a corrugated tube is used.

Although an embodiment of the present disclosure has been described in detail, the present invention is not limited to the above embodiment, and various modifications can be made without departing from the gist of the present invention.

### LIST OF REFERENCE NUMERALS

1 Wire harness

2 Flat wire (wire portion)

2a Upper and lower surfaces

2b Side face portions

20 Conductor

21 Strand

22 Insulating covering

3 Exterior member (corrugated sheet)

4 Tape (fixing member)

5 Integrated exterior member

51 Exterior member

52 Fixing member

8 Corrugated tube

81 Upper and lower surfaces

82 Side wall surfaces

9 Conventional wire harness

H1 Harness 1

H2 Harness 2

S Test piece

T Jig

W Cutout portion

x Width direction

y Axial direction

Z Height direction

1. A wire harness comprising:
a wire portion that includes at least one insulated wire including a conductor and an insulating covering covering an outer circumferential surface of the conductor, a cross section perpendicular to an axial direction of the wire portion having a flat shape that is longer in a width direction than in a height direction;
a pair of exterior members that are respectively in contact with two surfaces of the wire portion in the height direction; and
a fixing member fixing the pair of exterior members to each other with the wire portion sandwiched between the exterior members,
wherein the wire portion includes one insulated flat wire or includes a set of a plurality of insulated wires,
the exterior members are made of a material having a higher tensile modulus than the insulating covering and have a higher bending flexibility than the wire portion in the height direction, and
the fixing member fixes the pair of exterior members to each other at a plurality of fixing positions spaced apart from each other in the axial direction of the wire portion.

2. The wire harness according to claim 1,
wherein the exterior members have a higher bending flexibility than the wire portion in the width direction as well.

3. The wire harness according to claim 1,
wherein the two exterior members are each configured as a sheet material that has a bellows structure including ridges and grooves arranged next to each other in the axial direction of the wire portion.

4. The wire harness according to claim 1,
wherein, when the wire harness is supported so as to extend in a horizontal direction, the wire harness has, in both the width direction and the height direction, a drooping amount that is at least 70% of a drooping amount of the wire portion alone supported so as to extend in the horizontal direction.

5. The wire harness according to claim 1,
wherein the fixing member is constituted by a tape that has a higher flexibility than the exterior members.

6. The wire harness according to claim 5,
wherein the fixing member is spirally wound around an outer circumferential surface of an assembly constituted by the pair of exterior members and the wire portion with spaces left between turns of the fixing member in the axial direction of the wire portion.

7. The wire harness according to claim 1,
wherein the fixing member is not in contact with the wire portion except at end portions of the exterior members in the axial direction of the wire portion.

8. The wire harness according to claim 1,
wherein the pair of exterior members are each larger than the wire portion in the width direction.

9. The wire harness according to claim 1,
wherein the insulated wire is a flat wire that includes, as the conductor, a flat conductor obtained by flattening a twisted wire constituted by a plurality of strands that are twisted together.
